(19) United States
(12) Patent Application Publication
(10) Pub. No.: US 2023/0012422 A1
(43) Pub. Date: Jan. 12, 2023

(54) VEHICLE, LEAVE-BEHIND-IN-VEHICLE PREVENTION APPARATUS, AND METHOD

(71) Applicant: NEC Corporation, Minato-ku, Tokyo (JP)

(72) Inventor: Aki Hatakeyama, Tokyo (JP)

(73) Assignee: NEC Corporation, Minato-ku, Tokyo (JP)

(21) Appl. No.: 17/802,622

(22) PCT Filed: Mar. 12, 2020
(86) PCT No.: PCT/JP2020/010888

§ 371 Date: Aug. 26, 2022

(51) Int. Cl. G08B 21/02; G06V 20/56; B60H 1/00

(52) U.S. Cl. CPC G08B 21/02; G06V 20/56; B60H 1/00807

(57) ABSTRACT

A location information acquisition unit acquires vehicle location information indicating a location of a vehicle. A location determination unit determines whether or not the location indicated by the vehicle location information matches a registered location. A living body determination unit determines whether or not there is a living body present inside the vehicle under a state in which the vehicle is locked. A notification unit notifies, when it is determined that the location of the vehicle matches the registered location and that there is a living body present inside the vehicle, a user of the presence of the living body inside the vehicle.

### TECHNICAL FIELD

The present disclosure relates to a vehicle, a leave-behind-in-vehicle prevention apparatus, a method, and a computer-readable medium.

### BACKGROUND ART

As a related technique, Patent Literature 1 discloses a vehicle cabin temperature monitoring apparatus. Based on the conditions in the area surrounding a vehicle, the vehicle cabin temperature monitoring apparatus predicts a temperature change of a vehicle cabin of the vehicle. Further, the vehicle cabin temperature monitoring apparatus controls the air-conditioning process of the vehicle cabin based on the result of the prediction of the temperature change of the vehicle cabin. In a case where an abnormal increase in the temperature of the vehicle cabin is predicted in a situation where a child is inside the vehicle and the user can return to his/her own vehicle promptly, the vehicle cabin temperature monitoring apparatus notifies the user of the predicted danger. In a case of a situation where the user cannot return to his/her own vehicle promptly, the vehicle cabin temperature monitoring apparatus signals to people in the vicinity of the vehicle that help is needed using the vehicle lamps and the like or reports the predicted danger to a third party such as a manager of a parking space where the vehicle is parked and the like.

As another related technique, Patent Literature 2 discloses a human presence detection and reporting apparatus. The human presence detection and reporting apparatus detects the temperature inside a vehicle and estimates, based on the rate of change in the detected temperature, the time it will take for the vehicle interior temperature to reach a temperature dangerous for the human body. When a young child such as an infant is left unattended inside a vehicle, the human presence detection and reporting apparatus outputs a human presence detection report to a monitoring center or the like. Further, before the temperature inside the vehicle reaches a dangerous temperature, the human presence detection and reporting apparatus starts the engine of the vehicle and turns on the air conditioner to lower the temperature inside the vehicle.

### CITATION LIST

### Patent Literature

Patent Literature 1: Japanese Unexamined Patent Application Publication No. 2005-343386
Patent Literature 2: Japanese Unexamined Patent Application Publication No. 2002-063668

### SUMMARY OF INVENTION

### Technical Problem

According to Patent Literatures 1 and 2, when it is predicted that the temperature inside the vehicle will reach a dangerous temperature, the predicted danger is reported to the user or a third party. However, in Patent Literatures 1 and 2, the location of the vehicle is not taken into account in reporting the predicted danger. For this reason, if a child is left unattended inside a vehicle at a specific location such as on home premises, the user is not given any report of such state until the child is actually in danger.

In view of the aforementioned circumstances, an object of the present disclosure is to provide a vehicle, a leave-behind-in-vehicle prevention apparatus, a method, and a computer-readable medium, each adapted to reduce the risk of a living body such as a child from being left unattended inside a vehicle.

### Solution to Problem

In order to achieve the aforementioned object, the present disclosure provides:

location information acquisition means for acquiring vehicle location information indicating a location of a vehicle;

location determination means for determining whether or not the location indicated by the vehicle location information matches a registered location;

living body determination means for determining whether or not there is a living body present inside the vehicle under a state in which the vehicle is locked; and

notification means for notifying, when it is determined that the location of the vehicle matches the registered location and that there is a living body present inside the vehicle, a user of the presence of the living body inside the vehicle.

The present disclosure provides a vehicle equipped with a leave-behind-in-vehicle prevention apparatus, the leave-behind-in-vehicle prevention apparatus including:

location information acquisition means for acquiring vehicle location information indicating a location of a vehicle;

location determination means for determining whether or not the location indicated by the vehicle location information matches a registered location;

living body determination means for determining whether or not there is a living body present inside the vehicle under a state in which the vehicle is locked; and

notification means for notifying, when it is determined that the location of the vehicle matches the registered location and that there is a living body present inside the vehicle, a user of the presence of the living body inside the vehicle.

The present disclosure provides a leave-behind-in-vehicle prevention method including:

acquiring vehicle location information indicating a location of a vehicle;

determining whether or not the location indicated by the vehicle location information matches a registered location;

determining whether or not there is a living body present inside the vehicle under a state in which the vehicle is locked; and

notifying, when it is determined that the location of the vehicle matches the registered location and that there is a living body present inside the vehicle, a user of the presence of the living body inside the vehicle.

The present disclosure provides a non-transitory computer readable medium storing a program for causing a processor to execute processes of: acquiring vehicle location information indicating a location of a vehicle;

determining whether or not the location indicated by the vehicle location information matches a registered location;

determining whether or not there is a living body present inside the vehicle under a state in which the vehicle is locked; and

notifying, when it is determined that the location of the vehicle matches the registered location and that there is a living body present inside the vehicle, a user of the presence of the living body inside the vehicle.

### Advantageous Effects of Invention

A vehicle, a leave-behind-in-vehicle prevention apparatus, a method, and a computer-readable medium according to the present disclosure are adapted to reduce the risk of a living body such as a child from being left unattended inside a vehicle.

### BRIEF DESCRIPTION OF DRAWINGS

FIG. 1 is a block diagram schematically showing a leave-behind-in-vehicle prevention apparatus according to the present disclosure;

FIG. 2 is a block diagram showing a vehicle including a leave-behind-in-vehicle prevention apparatus according to an example embodiment of the present disclosure;

FIG. 3 is a block diagram showing a configuration example of the leave-behind-in-vehicle prevention apparatus;

FIG. 4 is a flowchart showing an operation procedure of the leave-behind-in-vehicle prevention apparatus; and

FIG. 5 is block diagram showing a hardware configuration of an electronic control apparatus.

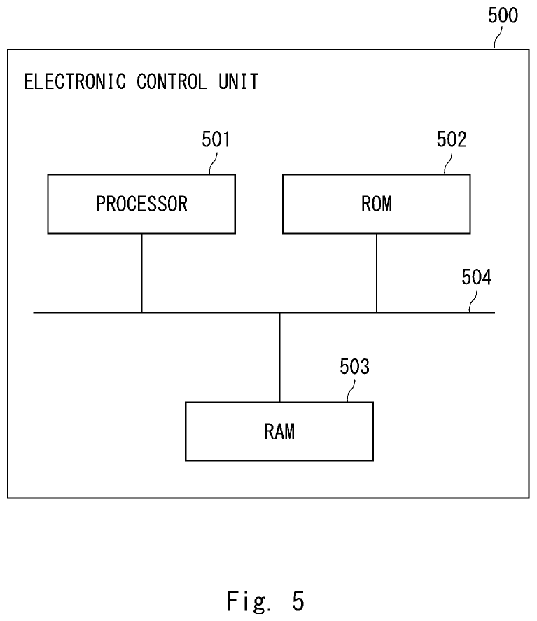

### EXAMPLE EMBODIMENT

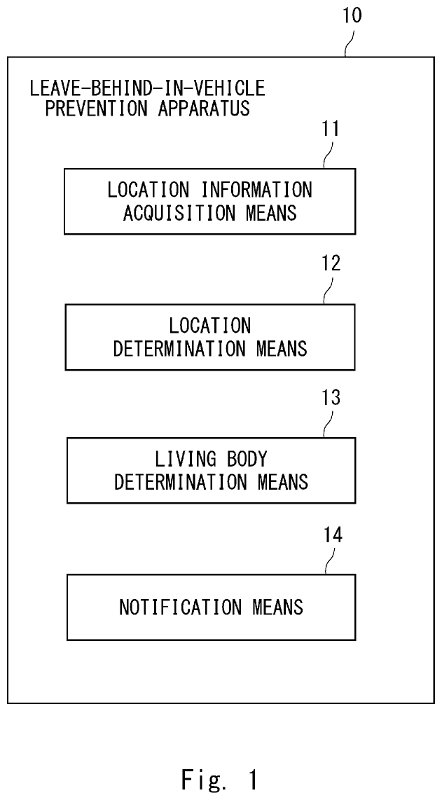

An overview of the present disclosure will be described prior to the description of the example embodiments of the present disclosure. FIG. 1 schematically shows a leave-behind-in-vehicle prevention apparatus according to the present disclosure. A leave-behind-in-vehicle prevention apparatus 10 includes location information acquisition means 11, location determination means 12, living body determination means 13, and notification means 14.

The location information acquisition means 11 acquires vehicle location information indicating a location of a vehicle. The location determination means 12 determines whether or not the location indicated by the vehicle location information matches a registered location. The living body determination means 13 determines whether or not there is a living body present inside the vehicle under a state in which the vehicle is locked. The notification means 14 notifies, when it is determined that the location of the vehicle matches the registered location and that there is a living body present inside the vehicle, the user of the presence of the living body inside the vehicle.

In the present disclosure, the location determination means 12 determines whether or not the location of the vehicle matches the registered location such as on home premises. The living body determination means 13 determines whether or not there is a living body present inside the vehicle under a state in which the vehicle is locked. The notification means 14 notifies, when it is determined that the location of the vehicle matches the registered location and that there is a living body present inside the vehicle under a state in which the vehicle is locked, the user of the presence of the living body inside the vehicle. By this configuration, a user is able to know that there is a living body left inside a locked vehicle whereby the user can return to his/her own vehicle and take the living body out of the vehicle. Accordingly, the risk of a living body such as a child being left unattended inside a vehicle can be reduced according to the present disclosure.

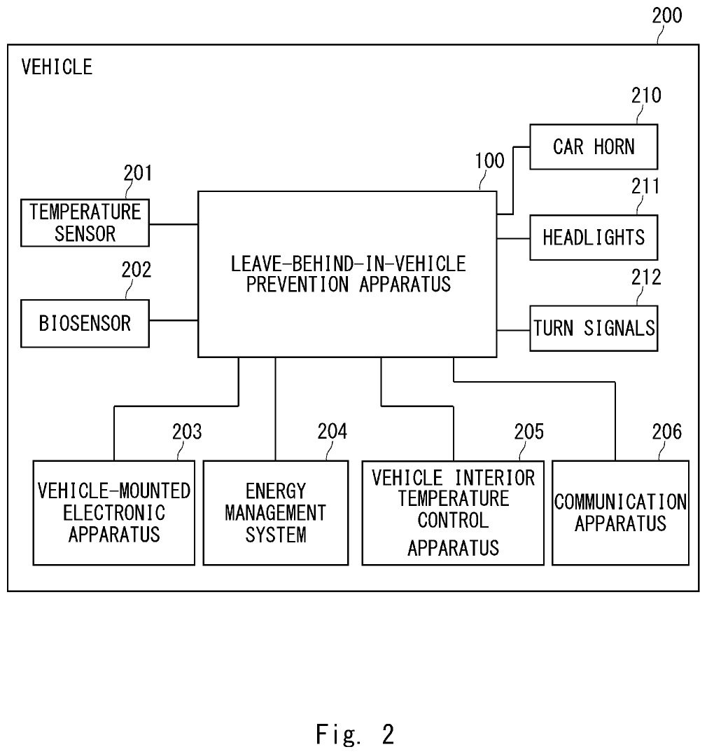

Hereinbelow, the example embodiments of the present disclosure will be described in detail with reference to the drawings. FIG. 2 shows a vehicle including a leave-behind-in-vehicle prevention apparatus according to an example embodiment of the present disclosure. The vehicle 200 includes a leave-behind-in-vehicle prevention apparatus 100, and a temperature sensor 201, a biosensor 202, a vehicle-mounted electronic apparatus 203, an energy management system 204, a vehicle interior temperature control apparatus 205, a communication apparatus 206, a car horn 210, headlights 211, and turn signals 212.

The temperature sensor 201 measures the temperature inside the vehicle 200. The biosensor 202 detects a living body present inside the vehicle. As the biosensor 202, for example, an infrared light camera, a seat sensor, or the like can be employed. The vehicle-mounted electronic apparatus 203 is an electronic apparatus capable of performing at least either one of image display or audio output. The vehicle-mounted electronic apparatus 203 is configured as, for example, a navigation apparatus or a display audio apparatus.

The energy management system 204 is an apparatus for managing energy that is a power source for the vehicle. The energy management system 204 manages, for example, remaining amount of fuel such as gasoline or the remaining battery level (electric power). The vehicle interior temperature control apparatus 205 is an apparatus capable of controlling the temperature inside the vehicle. The vehicle interior temperature control apparatus 205 controls, for example, an air conditioner or the like mounted on the vehicle, and controls the temperature inside the vehicle. The communication apparatus 206 performs communication with external apparatuses. The communication apparatus 206 is connected to, for example, a wireless network such as an LTE (Long Term Evolution) network.

The car horn 210 outputs sound. The headlights 211 output light to the front of the vehicle 200. The turn signals 212 are direction indicators. These components may be the same as those mounted on a normal vehicle.

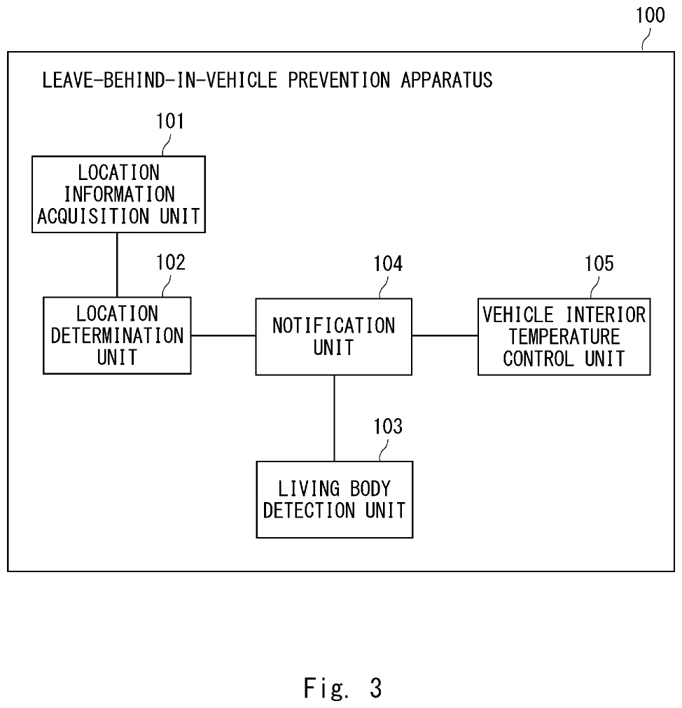

FIG. 3 shows a configuration example of the leave-behind-in-vehicle prevention apparatus 100. The leave-behind-in-vehicle prevention apparatus 100 includes a location information acquisition unit 101, a location determination unit 102, a living body detection unit 103, a notification unit 104, and a vehicle interior temperature control unit 105. The leave-behind-in-vehicle prevention apparatus 100 corresponds to the leave-behind-in-vehicle prevention apparatus 10 in FIG. 1.

The location information acquisition unit 101 acquires the location information of the vehicle. The location information acquisition unit 101 may acquire the location information of the vehicle using, for example, Global Navigation Satellite System (GNSS). Alternatively, the location information acquisition unit 101 may acquire the location information from the navigation apparatus mounted inside the vehicle. The location information acquisition unit 101 corresponds to the location information acquisition means 11 in FIG. 1.

The location determination unit 102 determines whether or not the location information of the vehicle acquired by the location information acquisition unit 101 indicates a pre-registered location. The location determination unit 102 determines, for example, whether or not the location information of the vehicle indicates a location of the home premises of the user or a parking space near the home premises. The pre-registered location is not limited to one location, and a plurality of locations may be registered in the location determination unit 102. The location determination unit 102 outputs the determination result to the notification unit 104. The location determination unit 102 corresponds to the location determination means 12 in FIG. 1.

The living body detection unit 103 determines whether or not there is a living body present inside the vehicle. Once the vehicle is locked, the living body detection unit 103 determines whether or not there is a living body such as a child or a pet present inside the vehicle using the biosensor 202 shown in FIG. 2. When the living body detection unit 103 determines that there is a living body present inside the vehicle, it notifies the notification unit 104 to that effect. The living body detection unit 103 corresponds to the living body determination means 13 in FIG. 1.

When it is determined that the location of the vehicle matches the registered location and that there is a living body present inside the vehicle, the notification unit 104 notifies the user of the presence of the living body inside the vehicle. The notification unit 104 notifies the user of the presence of the living body inside the vehicle by, for example, sending a message through the communication apparatus 206 to an electronic device such as a mobile phone held by the user. The notification unit 104 may cause at least one of the car horn 210, the headlights 211, and the turn signals 212 shown in FIG. 2 to operate to notify those in the vicinity of the vehicle of the presence of a living body inside the vehicle. The notification unit 104 corresponds to the notification means 14 in FIG. 1.

The notification unit 104 may further detect whether or not the driver (the user) is moving away from the vehicle and perform the aforementioned notification when the user has moved away from the vehicle by a predetermined distance or further. The notification unit 104 may detect the location of the user and determine whether or not the user is moving away from the vehicle based on, for example, images captured by a camera for capturing images of the area surrounding the vehicle. Alternatively, the notification unit 104 may determine, based on the radio field strength of a smart key held by the user, whether or not the user is moving away from the vehicle.

The vehicle interior temperature control unit (vehicle interior temperature control means) 105 controls the temperature inside of the vehicle. The vehicle interior temperature control unit 105 monitors the temperature inside of the vehicle using the temperature sensor 201 shown in FIG. 2. In the case where the vehicle is locked and there is a living body present inside the vehicle, the vehicle interior temperature control unit 105 predicts change in the vehicle interior temperature and predicts whether or not the vehicle interior temperature will rise or fall to a temperature that is dangerous for a living body.

When it is predicted that the vehicle interior temperature will become a temperature that is dangerous for a living body, the vehicle interior temperature control unit 105 informs a person present inside the vehicle interior by voice of the vehicle interior temperature being at a dangerous temperature using, for example, a vehicle-mounted electronic apparatus 203 shown in FIG. 2. Further, the vehicle interior temperature control unit 105 displays, on a display screen of the vehicle-mounted electronic apparatus 203, a message inquiring whether or not to operate the vehicle interior temperature control apparatus 205. When the person present inside the vehicle operates the vehicle-mounted electronic apparatus 203 and inputs an instruction, the vehicle interior temperature control unit 105 operates in accordance therewith.

When no instruction is input even after elapse of a predetermined time (a first predetermined time), for example, one minute, the vehicle interior temperature control unit 105 causes the vehicle interior temperature control apparatus 205 to operate. When the vehicle interior temperature control unit 105 causes the vehicle interior temperature control apparatus 205 to operate, the vehicle interior temperature control unit 105 notifies the notification unit 104 to that effect. The notification unit 104 then sends a message through the communication apparatus 206 to the user's electronic device that the vehicle interior temperature control apparatus 205 has been operated.

The vehicle interior temperature control unit 105 (the vehicle interior temperature control apparatus 205) checks whether or not there is a living body present in the area surrounding the vehicle using a camera for capturing images of the area surrounding the vehicle which is not shown. When, for example, there is no living body present within a two meter range of the area surrounding the vehicle and the vehicle interior temperature is higher than the outside temperature, the vehicle interior temperature control apparatus 205 opens a window of the vehicle just enough to allow the wind to pass through. The vehicle interior temperature control apparatus 205 determines whether or not a predetermined time (a second predetermined time) has elapsed after the window of the vehicle has been opened just enough to allow the wind to pass through. The vehicle interior temperature control apparatus 205 closes the window and operates the air conditioner after, for example, three minutes have elapsed since the window was opened. When, for example, there is a living body present within a two meter range of the area surrounding the vehicle, the vehicle interior temperature control apparatus 205 causes the air conditioner to operate without opening any window. The vehicle interior temperature control apparatus 205 starts the engine of the vehicle when causing the air conditioner to operate.

When the air conditioner is activated, the notification unit 104 checks the remaining fuel amount or the battery level using the energy management system 204. The notification unit 104 predicts the remaining time for the fuel to become empty or for the remaining battery level to become equal to or lower than a threshold value. When the remaining time is, for example, ten minutes, the notification unit 104 informs those in the area surrounding the vehicle of the presence of a living body inside the vehicle using an exterior speaker, which is not shown, or the like. When the remaining time is, for example, five minutes, the notification unit 104 reports to the authorities such as the police using the communication apparatus 206. The notification unit 104 may capture an image inside the vehicle using an in-vehicle camera and send the shot image to the police and so on. Using the vehicle-mounted electronic apparatus 203, the user can arbitrary set the time it will take to activate the air conditioner, the timing to report to the police, and the like.

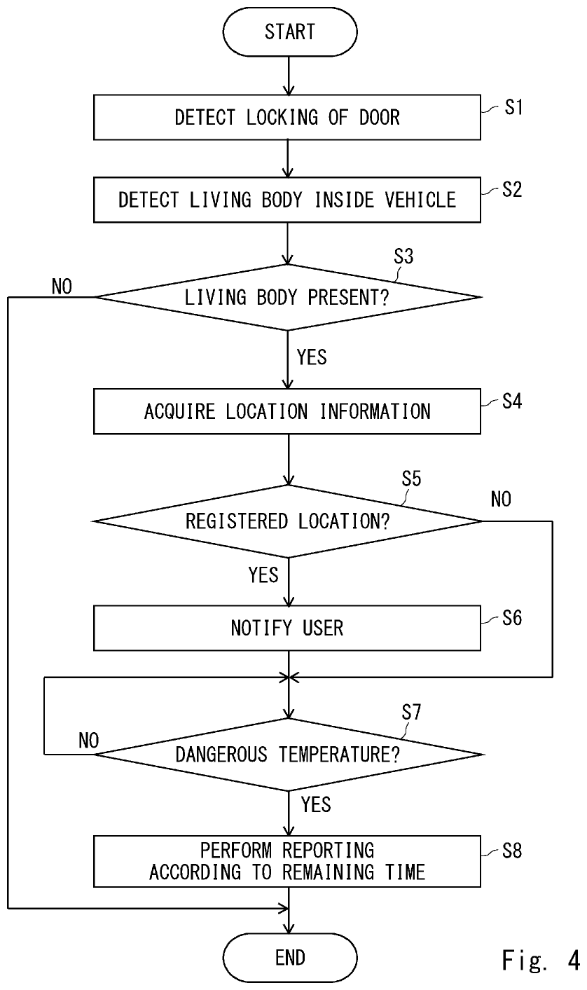

Next, the operation procedure is explained. FIG. 4 shows an operation procedure (a leave-behind-in-vehicle prevention method) of the leave-behind-in-vehicle prevention apparatus 100. The living body detection unit 103 detects locking of the door of the vehicle 200 (Step S1). The living body detection unit 103 detects a living body inside the vehicle using the biosensor 202 (Step S2). The living body detection unit 103 determines whether or not there is a living body present inside the vehicle (Step S3). When it is determined that there is no living body present inside the vehicle, the process ends.

When it is determined that there is a living body present inside the vehicle, the location information acquisition unit 101 acquires the vehicle location information (Step S4). The location determination unit 102 determines whether or not the location of the vehicle matches the location which has been pre-registered such as on home premises (Step S5). When it is determined that the location of the vehicle matches the registered location, the notification unit 104 notifies the user who has been pre-registered as the user corresponding to the vehicle of the presence of the living body inside the vehicle (Step S6). The user who received the notification can return to his/her vehicle and rescue the living body. When the location of the vehicle does not match the pre-registered location, Step S6 is not performed.

The vehicle interior temperature control unit 105 monitors the vehicle interior temperature and determines whether or not it is predicted that the vehicle interior temperature will reach a dangerous temperature (Step S7). When the vehicle interior temperature control unit 105 determines that the vehicle interior temperature is predicted to reach a dangerous temperature, it causes the vehicle interior temperature control apparatus 205 of the vehicle 200 to operate. After the vehicle interior temperature control apparatus 205 is operated, the notification unit 104 performs the aforementioned reporting according to the remaining time (Step S8).

In the present example embodiment, the notification unit 104 notifies the user of the presence of a living body inside the vehicle when the location at which the living body is left behind unattended inside the vehicle matches the location such as on home premises. For example, when the user returns home, the user might load/unload goods, lock the vehicle without getting a child such as an infant off the vehicle, and enters the house. In such a case, by receiving a notification from the notification unit 104, the user can immediately notice that he/she has left a child inside the vehicle whereby the risk of a living body such as a child being left behind unattended inside a vehicle can be reduced.

Further, in the present example embodiment, when there is a living body present inside a locked vehicle, the vehicle interior temperature control unit 105 causes the air conditioner to operate in accordance with the vehicle interior temperature and the elapsed time. Further, before the energy for operating the air conditioner is depleted, the notification unit 104 informs those in the area surrounding the vehicle of the presence of a living body inside the vehicle or reports to the authorities such as the police. By this configuration, it is possible to reduce the risk of a living body left unattended inside a vehicle from falling into a life-threatening situation.

In the present disclosure, the leave-behind-in-vehicle prevention apparatus 100 can be configured as an electronic control unit. FIG. 10 shows a hardware configuration of an electronic control apparatus that can be used for the leave-behind-in-vehicle prevention apparatus 100. An electronic control unit 500 includes a processor 501, a ROM (read only memory) 502, and a RAM (random access memory) 503. In the electronic control unit 500, the processor 501, the ROM (read only memory) 502, and the RAM (random access memory) 503 are connected with one another via a bus 504. Although illustration thereof is omitted, the electronic control unit 500 may include other circuits such as a peripheral circuit, a communication circuit, and an interface circuit.

The ROM 502 is a non-volatile storage apparatus. For example, a semiconductor storage apparatus such a flash memory having relatively small capacity is used for the ROM 502. The ROM 502 stores a program executed by the processor 501.

The aforementioned program can be stored and provided to the electronic control unit 500 using any type of non-transitory computer readable media. Non-transitory computer readable media include any type of tangible storage media. Examples of non-transitory computer readable media include magnetic storage media such as floppy disks, magnetic tapes, hard disk drives, etc., optical magnetic storage media such as magneto-optical disks, optical disks such as CD (compact disc), DVD (digital versatile disk), and semiconductor memories such as mask ROM, PROM (programmable ROM), EPROM (erasable PROM), flash ROM, RAM (random access memory), etc. The program may be provided to the electronic control unit using any type of transitory computer readable media. Examples of transitory computer readable media include electric signals, optical signals, and electromagnetic waves. Transitory computer readable media can provide the program to the electronic control unit via a wired communication line such as electric wires and optical fibers, or a wireless communication line.

The RAM 503 is a volatile storage apparatus. Any type of semiconductor memory device such as a DRAM (Dynamic Random Access Memory) or a SRAM (Static Random Access Memory) may be used for the RAM 503. The RAM 540 can be used as an internal buffer for temporarily storing data.

The processor 501 expands the program stored in the ROM 502 to the RAM 503 and executes the program. By causing the CPU 501 to execute the program, functions of each of the units of the leave-behind-in-vehicle prevention apparatus 100 can be realized.

As described above, the example embodiments of the present disclosure have been described in detail, but the present disclosure is not limited to the above-described example embodiments and other example embodiments obtained by changing or modifying the aforementioned example embodiments to the extent not departing from the spirit of the present disclosure are also included in the scope of the present disclosure.

For instance, the whole or part of the example embodiments disclosed above can be described as, but not limited to, the following supplementary notes.

[Supplementary Note 1]

A leave-behind-in-vehicle prevention apparatus comprising:

location information acquisition means for acquiring vehicle location information indicating a location of a vehicle;

location determination means for determining whether or not the location indicated by the vehicle location information matches a registered location;

living body determination means for determining whether or not there is a living body present inside the vehicle under a state in which the vehicle is locked; and

notification means for notifying, when it is determined that the location of the vehicle matches the registered location and that there is a living body present inside the vehicle, a user of presence of the living body inside the vehicle.

[Supplementary Note 2]

The leave-behind-in-vehicle prevention apparatus described in Supplementary Note 1, wherein the notification means detects whether or not the user is moving away from the vehicle and when the user is moving away from the vehicle, notifies the user of the presence of the living body inside the vehicle.

[Supplementary Note 3]

The leave-behind-in-vehicle prevention apparatus described in Supplementary Note 2, wherein the notification means detects, based on images captured by a camera for capturing images of an area surrounding the vehicle, whether or not the user is moving away from the vehicle.

[Supplementary Note 4]

The leave-behind-in-vehicle prevention apparatus described in Supplementary Note 2, wherein the notification means detects, based on a radio field strength of a smart key held by the user, whether or not the user is moving away from the vehicle.

[Supplementary Note 5]

The leave-behind-in-vehicle prevention apparatus described in any one of Supplementary Notes 1 to 4, wherein the registered location includes home premises or a parking space.

[Supplementary Note 6]

The leave-behind-in-vehicle prevention apparatus described in any one of Supplementary Notes 1 to 5, further comprising vehicle interior temperature control means for controlling a temperature inside of the vehicle.

[Supplementary Note 7]

The leave-behind-in-vehicle prevention apparatus described in Supplementary Note 6, wherein the vehicle interior temperature control means controls the temperature inside of the vehicle by controlling an air conditioner of the vehicle.

[Supplementary Note 8]

A vehicle equipped with a leave-behind-in-vehicle prevention apparatus, the leave-behind-in-vehicle prevention apparatus comprising:

location information acquisition means for acquiring vehicle location information indicating a location of a vehicle;

location determination means for determining whether or not the location indicated by the vehicle location information matches a registered location;

living body determination means for determining whether or not there is a living body present inside the vehicle under a state in which the vehicle is locked; and

notification means for notifying, when it is determined that the location of the vehicle matches the registered location and that there is a living body present inside the vehicle, a user of presence of the living body inside the vehicle.

[Supplementary Note 9]

The vehicle described in Supplementary Note 8, wherein the notification means detects whether or not the user is moving away from the vehicle and when the user is moving away from the vehicle, notifies the user of the presence of the living body inside the vehicle.

[Supplementary Note 10]

The vehicle described in Supplementary Note 9, further comprising a camera for capturing images of an area surrounding the vehicle.

wherein the notification means detects whether or not the user is moving away from the vehicle based on the images captured by the camera.

[Supplementary Note 11] The vehicle described in Supplementary Note 9, wherein the notification means detects whether or not the user is moving away from the vehicle based on a radio field strength of a smart key held by the user.

[Supplementary Note 12]

A leave-behind-in-vehicle prevention method comprising:

acquiring vehicle location information indicating a location of a vehicle;

determining whether or not the location indicated by the vehicle location information matches a registered location;

determining whether or not there is a living body present inside the vehicle under a state in which the vehicle is locked; and

notifying, when it is determined that the location of the vehicle matches the registered location and that there is a living body present inside the vehicle, a user of presence of the living body inside the vehicle.

[Supplementary Note 13] A non-transitory computer readable medium storing a program for causing a processor to execute processes of:

acquiring vehicle location information indicating a location of a vehicle;

determining whether or not the location indicated by the vehicle location information matches a registered location;

determining whether or not there is a living body present inside the vehicle under a state in which the vehicle is locked; and

notifying, when it is determined that the location of the vehicle matches the registered location and that there is a living body present inside the vehicle, a user of presence of the living body inside the vehicle.

### REFERENCE SIGNS LIST

10: LEAVE-BEHIND-IN-VEHICLE PREVENTION APPARATUS
11: LOCATION INFORMATION ACQUISITION MEANS
12: LOCATION DETERMINATION MEANS
13: LIVING BODY DETERMINATION MEANS
14: NOTIFICATION MEANS
100: LEAVE-BEHIND-IN-VEHICLE PREVENTION APPARATUS
101: LOCATION INFORMATION ACQUISITION UNIT
102: LOCATION DETERMINATION UNIT
103: LIVING BODY DETECTION UNIT
104: NOTIFICATION UNIT
105: VEHICLE INTERIOR TEMPERATURE CONTROL UNIT
200: VEHICLE
201: TEMPERATURE SENSOR
202: BIOSENSOR
203: VEHICLE-MOUNTED ELECTRONIC APPARATUS 204: ENERGY MANAGEMENT SYSTEM 205: VEHICLE INTERIOR TEMPERATURE CONTROL APPARATUS 206: COMMUNICATION APPARATUS 210: CAR HORN 211: HEADLIGHTS 212: TURN SIGNALS

What is claimed is:

1. A leave-behind-in-vehicle prevention apparatus comprising:
at least one memory storing instructions, and
at least one processor configured to execute the instructions to:
acquire vehicle location information indicating a location of a vehicle;
determine whether or not the location indicated by the vehicle location information matches a registered location;
determine whether or not there is a living body present inside the vehicle under a state in which the vehicle is locked; and
notify, when it is determined that the location of the vehicle matches the registered location and that there is a living body present inside the vehicle, a user of presence of the living body inside the vehicle.

2. The leave-behind-in-vehicle prevention apparatus according to claim 1, wherein the at least one processor is configured to execute the instructions to detect whether or not the user is moving away from the vehicle and when the user is moving away from the vehicle, notifies the user of the presence of the living body inside the vehicle.

3. The leave-behind-in-vehicle prevention apparatus according to claim 2, wherein the at least one processor is configured to execute the instructions to detect, based on images captured by a camera for capturing images of an area surrounding the vehicle, whether or not the user is moving away from the vehicle.

4. The leave-behind-in-vehicle prevention apparatus according to claim 2, wherein the at least one processor is configured to execute the instructions to detect, based on a radio field strength of a smart key held by the user, whether or not the user is moving away from the vehicle.

5. The leave-behind-in-vehicle prevention apparatus according to claim 1, wherein the registered location includes home premises or a parking space.

6. The leave-behind-in-vehicle prevention apparatus according to claim 1, the at least one processor is further configured to execute the instructions to control a temperature inside of the vehicle.

7. The leave-behind-in-vehicle prevention apparatus according to claim 6, wherein the at least one processor is configured to execute the instructions to control the temperature inside of the vehicle by controlling an air conditioner of the vehicle.

8. A vehicle equipped with a leave-behind-in-vehicle prevention apparatus, the leave-behind-in-vehicle prevention apparatus comprising at least one memory storing instructions and at least one processor configured to execute the instructions to:
acquire vehicle location information indicating a location of a vehicle;
determine whether or not the location indicated by the vehicle location information matches a registered location;
determine whether or not there is a living body present inside the vehicle under a state in which the vehicle is locked; and
notify, when it is determined that the location of the vehicle matches the registered location and that there is a living body present inside the vehicle, a user of presence of the living body inside the vehicle.

9. The vehicle according to claim 8, wherein the at least one processor is configured to execute the instructions to detect whether or not the user is moving away from the vehicle and when the user is moving away from the vehicle, notifies the user of the presence of the living body inside the vehicle.

10. The vehicle according to claim 9, further comprising a camera configured to capture images of an area surrounding the vehicle,
wherein the at least one processor is configured to execute the instructions to detect whether or not the user is moving away from the vehicle based on the images captured by the camera.

11. The vehicle according to claim 9, wherein the at least one processor is configured to execute the instructions to detect whether or not the user is moving away from the vehicle based on a radio field strength of a smart key held by the user.

12. A leave-behind-in-vehicle prevention method comprising:
acquiring vehicle location information indicating a location of a vehicle;
determining whether or not the location indicated by the vehicle location information matches a registered location;
determining whether or not there is a living body present inside the vehicle under a state in which the vehicle is locked; and
notifying, when it is determined that the location of the vehicle matches the registered location and that there is a living body present inside the vehicle, a user of presence of the living body inside the vehicle.

13. (canceled)
